(19) United States
(12) Patent Application Publication
(10) Pub. No.: US 2006/0236267 A1
(43) Pub. Date: Oct. 19, 2006

(54) Communications network planning system, method for creating communication network diagrams and control program for a communications network planning system

(76) Inventors: Thomas Gierschik, Wolfratshausen (DE); Rudolf Küchler, Baierbrunn (DE); Helmut Küchler, Münich (DE); Maria Küchler, Münich (DE)

Correspondence Address: MORRISON & FOERSTER LLP, 1650 TYSONS BOULEVARD, SUITE 300, MCLEAN, VA, 22102, US

(21) Appl. No.: 10/527,714

(22) PCT Filed: Sep. 12, 2003
(86) PCT No.: PCT/EP03/10173

§ 371 Date: Jan. 6, 2006

(30) Foreign Application Priority Data
Sep. 13, 2002 (EP) 02020646.2

(51) Int. Cl. G06F 17/00; G06F 9/00

(52) U.S. Cl. 715/853; 715/734; 715/738; 715/733

(57) ABSTRACT

The invention relates to a communications network planning system, in which an overview of sub-networks within a communications network is provided on a graphical user interface. The system is also provided with a selector field for selecting a graphical representation of a sub-network, comprising a hierarchically structured display of node types in the respective sub-network and a display of the links that exist between said node types. In addition, the system comprises a selector field for selecting a combined graphical representation of a respective section of interconnected sub-networks in the region of a sub-network gateway, said representation comprising a hierarchically structured display of node types that are present in the respective sub-network gateway region and a reproduction of connections that exist between said node types. The system is also provided with a control unit for controlling the graphical user interface according to selection entries that have been received by an input unit.

### CLAIM FOR PRIORITY

This application claims priority to International Application No. PCT/EP2003/10173, which was published in the German language on Sep. 12, 2003, which claims the benefit of priority to German Application No. 02020646.2 which was filed in the German language on Sep. 12, 2002, the contents of which are hereby incorporated by reference.

### TECHNICAL FIELD OF THE INVENTION

The present invention relates to a communications network planning system, method for creating network diagrams and control program for same.

### BACKGROUND OF THE INVENTION

EP 1 098 474 A1 describes a communications network modeling system which incorporates a network data model, and which both creates and manages a database of functions and a database of devices. The database of functions and the database of devices are linked to each other, and are used for the creation of a network model incorporating paths and connections. A control device has an interactive relationship with one or more system modules, which use the network data model for special functions, for example network planning.

EP 0 460 843 A2 discloses a computerized network planning installation which has a display device for showing a communications network which has numerous nodes. To each of the nodes are assigned numerous subordinate nodes, with the subordinate nodes having a predefined traffic link to the assigned node and to at least one other node. In response to a user input, subordinate nodes which are assigned to a selected node are determined. In addition, the subordinate nodes which have a more intensive traffic link to the one or more nodes other than the selected node are determined, so that a change of assignment can be made, if appropriate.

Until now, network planning or network documentation facilities have broken down the representation of a network into an overview diagram, schematic diagram and inventory diagram of the complete system or selected subnetworks, as applicable. Different subnetworks are generally not represented in a uniform and systematic way. When different representations are compared or analyzed, this often leads to misinterpretations, when representations which have a similar appearance ought actually to be interpreted differently.

### SUMMARY OF THE INVENTION

The present invention discloses a communications network planning system for the comprehensible, compact representation of informative data for effective network planning, a method for creating corresponding communications network diagrams and a suitable control program for the communications network planning system.

In one embodiment of the present invention, there is uniform representation of subnetworks with hierarchically structured details of the node types present in the subnetwork concerned and of the links which exist between the node types. This makes possible a reliable and rapid analysis of the representations of different subnetworks. Furthermore, the topologies of subnetworks can be compared relative to each other, using a combined graphical representation of subnetworks which are linked to one another, showing an extract of each in the region of an interface between them. This assists in avoiding any combination of functions from different subnetworks which have no direct topological link.

### BRIEF DESCRIPTION OF THE DRAWINGS

The present invention is explained in more detail below for an exemplary embodiment, with reference to the exemplary drawings, in which:

FIG. 1 an overview, displayed on a graphical user interface of a communications network planning system, of subnetworks within a communications network.

FIG. 2 a representation of a subnetwork on the graphical user interface, with details of the functionality of the node types which are present in the subnetwork.

FIG. 3 a representation of a subnetwork on the graphical user interface, with details of the node counts and node locations.

FIG. 4 a representation of a subnetwork on the graphical user interface, with details of the infrastructure installation products and their vendors.

FIG. 5 a combined representation on the graphical user interface of an extract from each of two subnetworks which are connected to each other, in the region of a subnetwork interface.

### DETAILED DESCRIPTION OF THE INVENTION

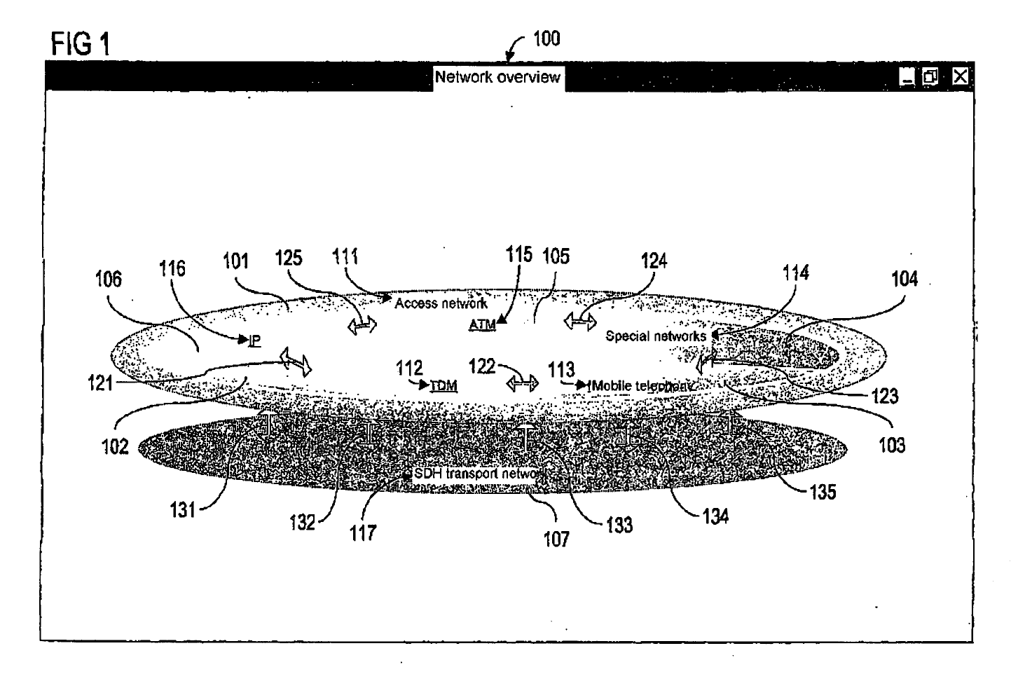

FIG. 1 shows an overview 100, displayed on a graphical user interface of a communications planning system, of subnetworks 101-107 within a communications network. The communications network planning system is realized, for example, by a normal data processing system, not shown, on which an operating system with a graphical user interface is installed. The overview 100 of the subnetworks 101-107 is displayed, for example, in a special display area of a display device assigned to the data processing system. In the context of computer operating systems with graphical user interfaces, such a display area is also called a window. In the present exemplary embodiment, the communications network incorporates a subscriber-side access network 101, a digital trunk dialing network 102 using time division multiplex (TDM) technology, a mobile telephony network 103, special networks 104, an ATM network (ATM—asynchronous transfer mode), a packet data network 106 using IP technology (IP—internet protocol) and an SDH transport network 107 (SDH—synchronous digital hierarchy).

In addition, the overview 100 of the subnetworks 101-107 incorporates selectors 111-117 for selecting a graphical representation of each of the subnetworks 101-107. The selectors 111-117 are implemented, for example, using a hyperlink technique, so that the graphical representation of the subnetwork concerned, 101-107, can be called up by selecting a text or graphic element, as applicable, assigned to the hyperlink.

In addition to the above, the overview 100 of the subnetworks 101-107 incorporates selectors 121-125, 131-135 for selecting a combined graphical representation for subnetworks which are linked to each other, showing an extract of each in the region of a subnetwork interface. By selecting a graphic element assigned to the relevant selector 121-125, 131-135, the desired combined graphical representation of a subnetwork interface can be called up.

The selectors 111-117, 121-125, 131-135 can be activated by means of an input unit, which is not shown in more detail, which is assigned to the data processing system used to realize the communications network planning system. The data processing system has in addition a control unit for activating the graphical user interface in accordance with the selection inputs received from the input unit. For the purpose of controlling the communications network planning system, a control program is provided, and this can be loaded into a working memory of the data processing system and has at least one section of code such that, when it is being executed—that is when the control program runs—the steps explained as part of the description of the present exemplary embodiment are worked through.

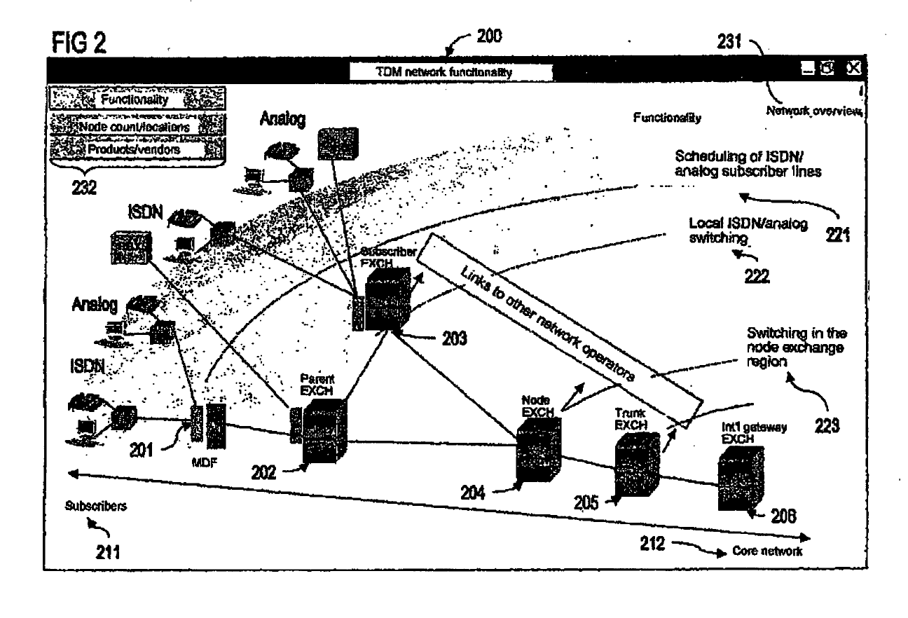

After activation of a selector 111-117 for the purpose of making a graphical selection of a subnetwork 101-107, the graphical representation of the selected subnetwork is output on the graphical user interface of the communications network planning system. In the considerations which follow it is assumed that selector 112 for the digital trunk dialing network 102 has been activated. A representation 200 of the digital trunk dialing network 102 is then output on the graphical user interface, with details of the functionality of the node types present in the digital trunk dialing network 102, as shown in FIG. 2.

The representation 200 of the digital trunk dialing network 102 incorporates hierarchically structured details of node types 201-206 which are present in the digital trunk dialing network 102 and a representation of the links which exist between these node types 201-206. The links thus represent connections or paths. The node types present in the digital trunk dialing network 102 include main distribution frames 201, parent exchanges 202, subscriber exchanges 203, node exchanges 204, trunk exchanges 205 and international gateway exchanges 206. Here, the hierarchically structured details of the node types 201-206 present in the digital trunk dialing network 102 are output according to the network hierarchy level to which the node types concerned 201-206 can be assigned, between the subscribers 211 and the core network 212. Accordingly, the node types 201-206 present in the digital trunk dialing network 102 are arranged in a hierarchically descending sequence, first into international gateway exchanges 206, then into trunk exchanges 205, node exchanges 204, subscriber exchanges 203 and parent exchanges 202, and finally into main distribution frames 201. To each of the node types 201-206 present in the digital trunk dialing network 102 are assigned details 221-223 about their particular functionality, which are incorporated by the representation 200 of the digital trunk dialing network 102 as shown in FIG. 2. For example, assigned to the main distribution frame 201 are the details 221 “Scheduling of ISDN/analog subscriber lines”. In a corresponding manner, the details 222 “Local ISDN/analog switching” are assigned to the parent exchanges 202 and the subscriber exchanges 203. In addition, the details 223, “Switching in the node exchange region” are assigned to the node exchanges 204.

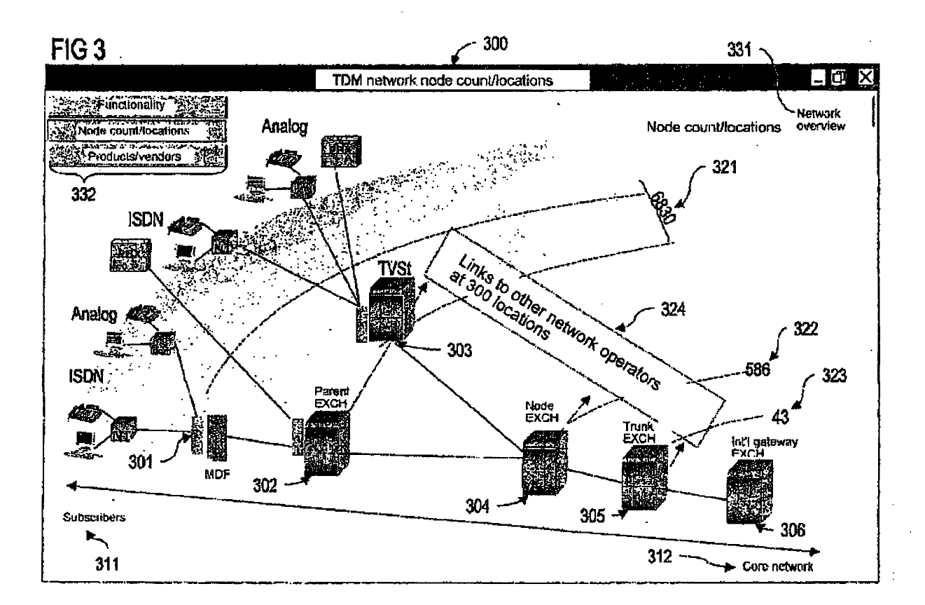

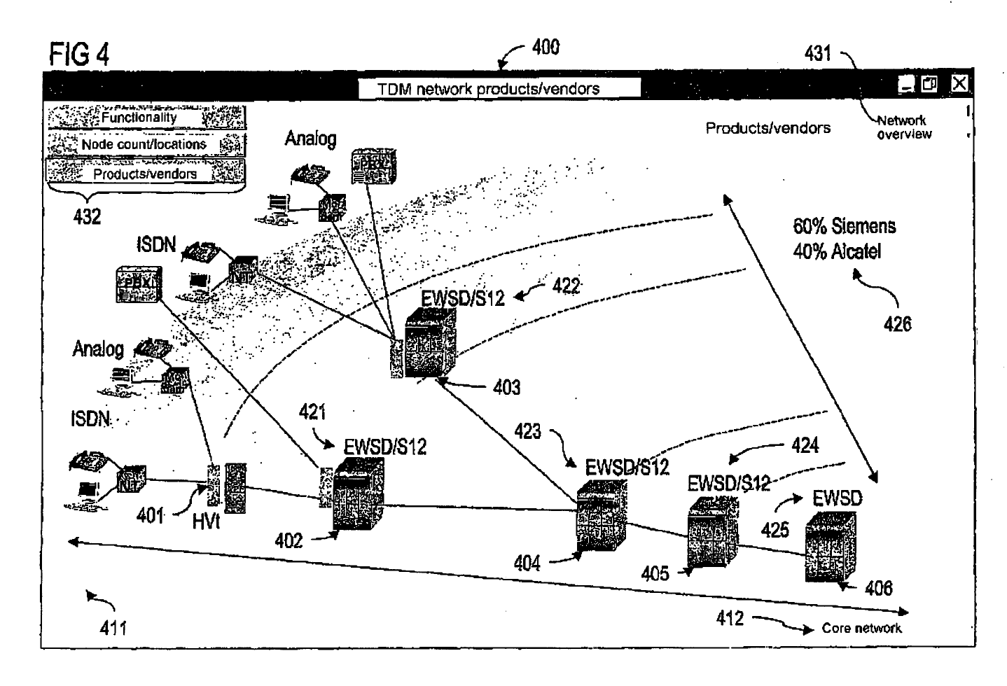

The representation 200 of the digital trunk dialing network 102, on the graphical user interface of the communications network planning system, shown in FIG. 2, incorporates in addition a selector 231 for selecting a network overview corresponding to FIG. 1, and selectors 232 for selecting representations 300, 400 of the digital trunk dialing network 102 with details respectively of the node counts and node locations, as shown in FIG. 3, or with details of the infrastructure installation products and their vendors, as shown in FIG. 4.

The representation 300 of the digital trunk dialing network 102 in FIG. 3 incorporates hierarchically structured details of the node types 301-306 present in the digital trunk dialing network 102 and details of the links which exist between these node types 301-306 and, in this respect, corresponds to the representation 200 of the digital trunk dialing network 102 as shown in FIG. 2. Again, all the node types 301-306 are arranged, as shown in FIG. 3, according to the network hierarchy level to which the node types 301-306 concerned can be assigned, between the subscribers 311 and the core network 312. By comparison with the representation 200 of the digital trunk dialing network 102 as shown in FIG. 2, the representation 300 of the digital trunk dialing network 102 shown in FIG. 3 incorporates, in place of the details 221-223 about the functionality of the node types 201-206 concerned, details 321-324 about numbers of nodes per node type and about numbers of locations per node type. Here too, the numbers of locations can be summarized for several node types. Like the representation 200 of the digital trunk dialing network 102 shown in FIG. 2, the representation 300 of the digital trunk dialing network 102 shown in FIG. 3 has a selector 331 for selecting a network overview as shown in FIG. 1, and selectors 332 for selecting a representation of the digital trunk dialing network 102, showing alternative details.

The representation 400 of the digital trunk dialing network 102 as shown in FIG. 4 is hierarchically structured, in the same way as the representations 200, 300 shown in FIGS. 2 and 3. Thus, node types 401-406 present in the digital trunk dialing network 102 are output according to the network hierarchy level to which they can be assigned, between the subscribers 411 and the core network 412. Instead of the details 221-223 about the functionality of the node types 201-206, the representation 400 of the digital trunk dialing network 102 shown in FIG. 4 incorporates details 421-425 about infrastructure installation products and details 426 about the vendors of these infrastructure installation products. The level of detail in the vendor information can here be arranged so that it incorporates a statement about the vendors, as a percentage across all the node types 401-406 considered. The representation 400 of the digital trunk dialing network 102 shown in FIG. 4 again incorporates a selector 431 for selecting a network overview as shown in FIG. 1 and selectors 432 for selecting alternative types of representation of the digital trunk dialing network 102.

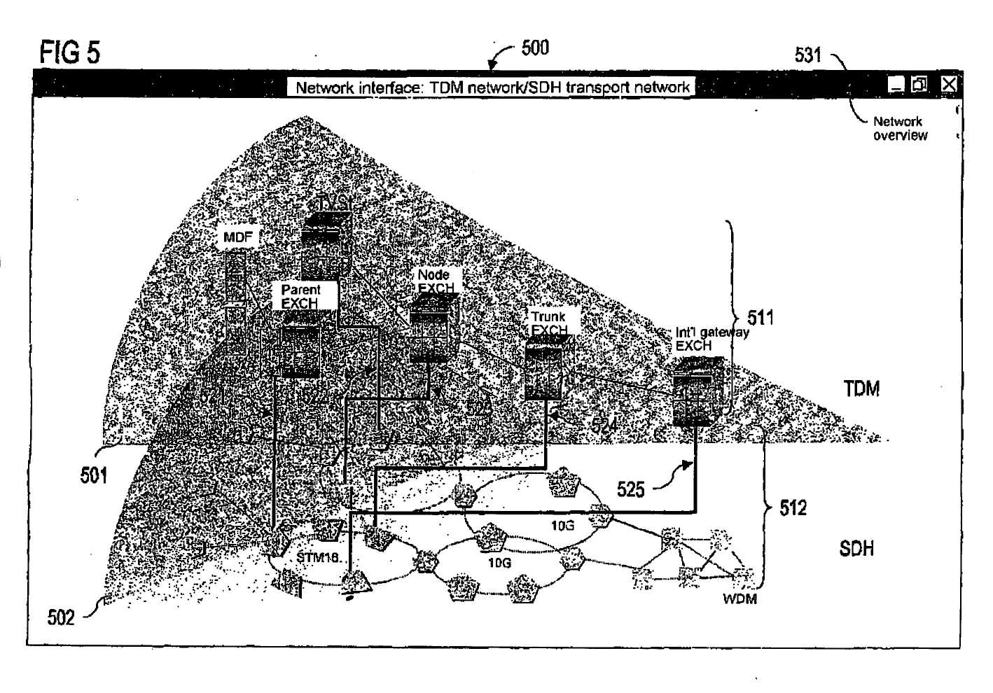

FIG. 5 shows a combined representation 500 of the graphical user interface of the communications network planning system, incorporating an extract from each of two mutually linked subnetworks, in the region of a subnetwork interface. A representation 500 of this type can be selected by activating one of the selectors 131-135, shown in FIG. 1, for selecting a representation of a subnetwork interface. We consider below the case in which a representation of a subnetwork interface, between the digital trunk dialing network 102 and the SDH transport network 107, is selected. The representation 500 of the subnetwork interface between the digital trunk dialing network 102 and the SDH transport network 107 incorporates hierarchically structured details of node types 511, 512 which are present in the subnetwork interface region concerned 501, 502, and details of subnetwork tie lines 521-525 which exist between these node types 511, 512. In an analogous way to the hierarchically structured representation 200, 300, 400 of the digital trunk dialing network 102, as shown in FIGS. 2 to 4, the node types 511, 512 which are present in the subnetwork interface regions concerned are structured according to the network hierarchy level to which they can be assigned, between the subscriber access and transport networks. In addition, the representation 500 of the subnetwork interface between the digital trunk dialing network 102 and the SDH transport network 107 as shown in FIG. 5 has a selector 531 for selecting a network overview, as in FIG. 1.

In addition to the selectors 231-232, 331-332, 431-432, 531 as shown in FIGS. 2 to 5, the representations 200, 300, 400, 500 can also have a selector for printing out a graphical representation of the subnetwork concerned, or a selector for printing out a combined graphical representation of extracts of each of the interlinked subnetworks in the region of a subnetwork interface. A printer, linked to the communications network planning system either directly or via a network, can be activated to print out communications network diagrams, in accordance with the selection details received on input units assigned to the communications network planning system. In this way, it is possible to generate communications network diagrams which correspond essentially to the representations 200, 300, 400, 500 of a subnetwork or a subnetwork interface, as applicable, shown in FIGS. 2 to 5.

The use of the present invention is not restricted to the exemplary embodiment described here.

What is claimed is:

1. A communications network planning system, comprising:
a graphical user interface having
an overview of subnetworks within a communications network, including:
a first selector for selecting a graphical representation of a subnetwork, which incorporates hierarchically structured details of node types present in the subnetwork, and details of links which exist between the node types;
a second selector for selecting a combined graphical representation of an extract of each subnetwork for interlinked subnetworks, in a region of a sub-network interface, which includes hierarchically structured details of the node types present in the region of the subnetwork interface concerned, and details of the links which exist between the node types; and
a control unit for activating the graphical user interface in accordance with selection inputs received from an input unit.

2. The system according to claim 1, wherein the details of node types, present in the subnetwork and/or the region of a subnetwork interface, are hierarchically structured according to the network hierarchy level to which the node concerned can be assigned, between the subscriber access network and the transport network.

3. The system according to claim 1, wherein the graphical representation of a subnetwork incorporates details of the functionality of the node types concerned.

4. The system according to claim 1, wherein the graphical representation of a subnetwork incorporates details of the nodes for each node type and/or the numbers of locations for each node type.

5. The system according to claim 1, wherein the graphical representation of a subnetwork incorporates details of the infrastructure installation products and/or their vendors, for the node types concerned.

6. A method for creating communications network diagrams, comprising:
providing, through a graphical user interface of a communications network planning system,
a first selector for printing out a graphical representation of a subnetwork, which incorporates hierarchically structured details of node types present in the subnetwork and details of links which exist between the node types, and
a second selector for printing out a combined graphical representation of an extract, for linked subnetworks, of each subnetwork in a region of a subnetwork interface, which incorporates hierarchically structured details of node types present in a region of the subnetwork interface concerned, and details of links which exist between the node types; and
activating a printer device assigned to the communications network planning system to print out communications network diagrams in accordance with selection inputs received from an input unit.

7. A control program for a communications network planning system, which can be loaded into a working memory of a control program device and which has at least one section of code such that, when executed, performs:
providing, through a graphical user interface of the communications network planning system,
an overview of subnetworks within a communications network,
providing a first selector for selecting a graphical representation of a subnetwork, which incorporates hierarchically structured details of node types present in the subnetwork concerned and details of links which exist between the node types,
providing a second selector for selecting a combined graphical representation of an extract, for linked subnetworks, of each subnetwork in a region of a subnetwork interface, which incorporates hierarchically structured details of node types present in the region of the subnetwork interface, and details of links which exist between the node types; and
activating the graphical user interface to display a selected subnetwork and/or subnetwork interface, in accordance with selection inputs received from an input unit, when the control program is executed in the control program device.
